(19) United States
(12) Patent Application Publication
(10) Pub. No.: US 2023/0003251 A1
(43) Pub. Date: Jan. 5, 2023

(54) BALL HEAD

(71) Applicant: CHIEN-TING LIN, Santa Fe Springs, CA (US)

(72) Inventor: CHIEN-TING LIN, Santa Fe Springs, CA (US)

(21) Appl. No.: 17/941,460

(22) Filed: Sep. 9, 2022

Related U.S. Application Data
(63) Continuation-in-part of application No. 16/872,650, filed on May 12, 2020, now abandoned.

(51) Int. Cl. F16C 11/10; F16C 11/06

(52) U.S. Cl. CPC F16C 11/106; F16C 11/0614; F16C 11/0647

(57) ABSTRACT

A ball head includes: a main body provided with ball body and fastener accommodating portions adjacent to each other in an up-and-down direction; a ball body provided with a threaded rod extending outward therefrom; and a fastener. The ball body and fastener accommodating portions are respectively formed with openings respectively extending upward and downward and having diameters respectively smaller than the diameters thereof, and communicated with an external space through a notch of the main body, wherein a fixing assembly is disposed at the notch. The notch can be expanded, such that the fastener and the ball body are respectively placed into the fastener and ball body accommodating portions. The notch can be further contracted by locking the fixing assembly tight and thus the ball body is non-rotatable, while the notch can also be expanded by loosening the fixing assembly and thus the ball body is rotatable.

### CROSS-REFERENCE TO RELATED APPLICATION

This application is a continuation-in-part of U.S. patent application Ser. No. 16/872,650, filed on May 12, 2020, which claims the priority of Chinese patent application No. 201920677298.8, filed on May 13, 2019. All of the above-referenced applications are incorporated by reference herein.

### BACKGROUND OF THE INVENTION

### 1. Field of the Invention

The present invention relates to a ball head, and more particularly, to a ball head having a main body with a notch capable of being expanded to a predetermined angle.

### 2. The Prior Arts

Generally, conventional ball heads are made of metal material or plastic material. For the metal ball head, during assembly, a ball body and a base are sequentially placed into a main body through a bottom thereof, and then a screw is screwed into the ball head from a side surface thereof. By screwing the screw against a recess position on an upper portion of the base, the base is pushed upward against the ball body, thereby making the ball body non-rotatable. The disadvantage thereof is that the metal material is too heavy.

For the plastic ball head, during assembly, the ball body can be squeezed from a top thereof into the main body due to the elasticity of plastic material, and then the ball body is held against by a side fastener, thereby making the ball body non-rotatable. The disadvantage thereof is that the ball body is easy to fall from a height due to unexpected detachment, thereby causing a damage to the equipment installed on the ball head.

US 2018/0203331 A1 discloses an adjustable clamp. A housing 152 of the adjustable clamp includes a first housing segment 180 and a second housing segment 182, which define a bolt accommodating portion and a ball accommodating portion. The two housing segments are connected by a hinge to each other, so as to be rotated with each other to open or close the housing. It includes relatively more components and is cumbersome in assembling, thereby causing a relatively high manufacturing cost.

CN 201672221 U discloses a ball head. A main body 20 of the ball head is used for accommodating a ball body 10. The ball body 10 is placed into the main body 20 from a bottom thereof. The main body 20 is mounted at a base 80. However, the assembling of the main body and the base may be easily loosened due to wear of the parts. Additionally, this structural design is not simple enough.

US 2007/0138358 A1 discloses a fastening mechanism mounted on a suction cup, which includes a positioning assembly 3 for fastening the pivotal support assembly 2 including a ball 20 placed in the receptacle of the body 11. This structural design is also not simple enough.

In view of the shortcomings of the prior arts, it is necessary to provide a ball head, which is simple in structure, easy in assembling, and low in manufacturing cost.

### SUMMARY OF THE INVENTION

In order to overcome the problems of the conventional ball head that is too heavy, has a risk of falling, is not simple in structure design, or is cumbersome in assembling, the present invention provides a ball head, wherein a main body is provided with a ball body accommodating portion and a fastener accommodating portion. The main body is provided with a notch extending from a ball body accommodating opening to a fastener accommodating opening. The notch of the main body can be expanded to a predetermined angle, so that the fastener and the ball body are sequentially and respectively placed into the fastener accommodating portion and the ball body accommodating portion, and then both sides of the notch are forced to be close to each other. The notch can be constrained by locking a fixing assembly tight and thus the ball body is non-rotatable, while the fixing assembly can also be loosened and thus the ball body is rotatable. In the present invention, by using plastic material, the heavy weight problem can be solved; and further by providing a notch, the ball body can prevent from falling off due to the unexpected detachment, thereby avoiding the damage to the equipment installed on the ball head.

The technical solution adopted by the present invention to solve the technical problems is as follows. The present invention provides a ball head including a main body, a ball body, and a fastener. The main body is made of an elastic material and integrally formed by a molding manner to be a single piece. The main body has a ball body accommodating portion and a fastener accommodating portion, which are adjacent to each other in an up-and-down direction. The ball body accommodating portion is formed with a ball body accommodating opening extending upward to an external space, and the ball body accommodating opening has a diameter smaller than that of the ball body accommodating portion. The fastener accommodating portion is formed with a fastener accommodating opening extending downward to the external space, and the fastener accommodating opening has a diameter smaller than that of the fastener accommodating portion. The main body is provided with a notch at a side surface thereof extending from the ball body accommodating opening to the fastener accommodating opening. The ball body accommodating portion and the fastener accommodating portion are communicated with the external space through the notch. A fixing assembly is disposed at both sides of the notch at a position close to the ball body accommodating opening. The ball body is provided with a threaded rod extending outward therefrom. A platform is disposed on the threaded rod and provided with a platform nut at a center of the platform. The threaded rod and the platform nut are coupled with each other and rotatable with respect to each other, so as to adjust a position of the platform relative to the threaded rod. In assembling, the notch of the main body can be expanded to a predetermined angle, so that the fastener is placed into the fastener accommodating portion from top to bottom, the ball body is placed into the ball body accommodating portion from top to bottom from the ball body accommodating opening, and the threaded rod penetrates outward through the ball body accommodating opening, and then due to the elasticity of the main body, after the ball body is placed into the ball body accommodating portion, the both sides of the notch of the main body are forced to be close to each other. The notch can be further contracted by locking the fixing assembly tight, such that the ball body accommodating portion clamps the ball body and thus the ball body is non-rotatable. The notch can also be expanded by loosening the fixing assembly, such that the ball body accommodating portion releases the ball body and thus the ball body is rotatable.

Preferably, the main body is provided with a threaded rod accommodating opening opposite to the notch, and the threaded rod accommodating opening extends from the ball body accommodating opening to a proper position on the main body.

Preferably, the fastener is a nut coupled with a first object through the fastener accommodating opening.

Preferably, the fastener is a screw coupled with a second object through the fastener accommodating opening.

The present invention has the beneficial effects that the weight of the ball head can be reduced, the ball body of the ball head can be prevented from falling off, and the ball head can be coupled with other objects through a fastening screw or nut, thereby increasing the portable convenience, the using safety, and the diversity of using the ball head.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective schematic view of a ball head according to a first embodiment of the present invention;

FIG. 2 is an exploded perspective schematic view of the ball head of the first embodiment of the present invention;

FIG. 3A is a perspective schematic view of a main body according to the first embodiment of the present invention;

FIG. 3B is a perspective schematic view of the main body of the first embodiment of the present invention, which shows a notch of the main body is expanded to a predetermined angle;

FIG. 4A is a perspective schematic view showing the assembling of a fastener according to the first embodiment of the present invention;

FIG. 4B is a perspective schematic view showing the assembling of a ball body according to the first embodiment of the present invention;

FIG. 4C is a perspective schematic view showing a state after the assembling of the ball body according to the first embodiment of the present invention;

FIG. 4D is a perspective schematic view showing the assembling of a fixing assembly according to the first embodiment of the present invention;

FIG. 5A is a perspective schematic view of the ball head of the first embodiment of the present invention viewed from another view angle;

FIG. 5B is a perspective schematic view showing a threaded rod is rotated into a threaded rod accommodating opening according to the first embodiment of the present invention;

FIG. 6 is a perspective schematic view showing a state before the ball head of the first embodiment of the present invention is assembled with a first object; and

FIG. 7 is a perspective schematic view showing a state before a ball head according to a second embodiment of the present invention with a second object.

### DETAILED DESCRIPTION OF THE PREFERRED EMBODIMENT

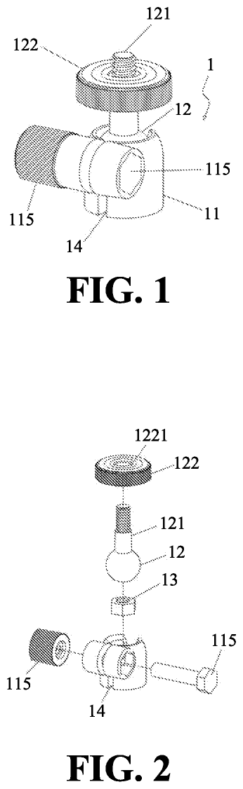

The accompanying drawings are included to provide a further understanding of the invention, and are incorporated in and constitute a part of this specification. FIGS. 1-7 illustrate embodiments of the invention and, together with the description, serve to explain the principles of the invention. This illustration is not intended to limit the embodiments of the present invention, but is one of the embodiments of the present invention.

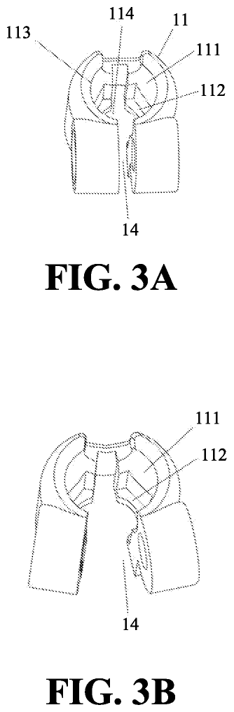

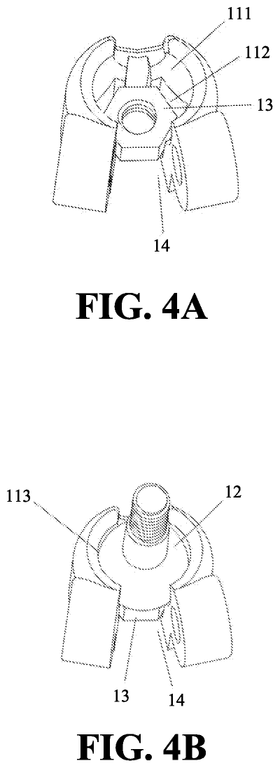

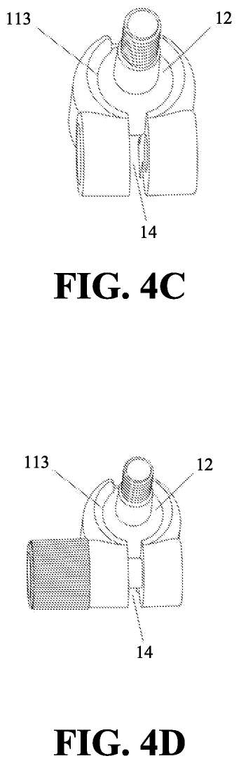

As shown in FIGS. 1-5, a ball head 1 according to a first embodiment of the present invention includes a main body 11, a ball body 12, and a fastener 13. The main body 11 is made of an elastic material, preferably a plastic material, and integrally formed by a molding manner to be a single piece. The main body 11 has a ball body accommodating portion 111 and a fastener accommodating portion 112, which are adjacent to each other in an up-and-down direction. The ball body accommodating portion 111 is formed with a ball body accommodating opening 113 extending upward to an external space. The ball body accommodating opening 113 has a diameter smaller than that of the ball body accommodating portion 111. The fastener accommodating portion 112 is formed with a fastener accommodating opening 114 extending downward to the external space. The fastener accommodating opening 114 has a diameter smaller than that of the fastener accommodating portion 112. The main body 11 is provided with a notch 14 at a side surface thereof extending from the ball body accommodating opening 113 to the fastener accommodating opening 114. The ball body accommodating portion 111 and the fastener accommodating portion 112 are communicated with the external space through the notch 14. A fixing assembly 115 is disposed at both sides of the notch 14 at a position close to the ball body accommodating opening 113. The ball body 12 is provided with a threaded rod 121 extending outward from the ball body 12. A platform 122 is disposed on the threaded rod 121 and provided with a platform nut 1221 at a center of the platform 122. The threaded rod 121 and the platform nut 1221 are coupled with each other and rotatable with respect to each other, so as to adjust a position of the platform 122 relative to the threaded rod 121. As shown in FIGS. 3A and 3B, in assembling, the notch 14 of the main body 11 can be expanded to a predetermined angle. Then, as shown in FIG. 4A, the fastener 13 is placed into the fastener accommodating portion 112 from top to bottom from the ball body accommodating opening 113. Next, as shown in FIG. 4B, the ball body 12 is placed into the ball body accommodating portion 111 from top to bottom from the ball body accommodating opening 113, and the threaded rod 121 penetrates outward through the ball body accommodating opening 113. Subsequently, as shown in FIG. 4C, due to the elasticity of the main body 11, after the ball body 12 is placed into the ball body accommodating portion 111, the both sides of the notch 14 of the main body 11 are forced to be close to each other. Finally, as shown in FIG. 4D, the notch 14 can be further contracted by locking the fixing assembly 115 tight, such that the ball body accommodating portion 111 clamps the ball body 12 and thus the ball body 12 is non-rotatable; and the notch 14 can also be expanded by loosening the fixing assembly 115, such that the ball body accommodating portion 111 releases the ball body 12 and thus the ball body 12 is rotatable.

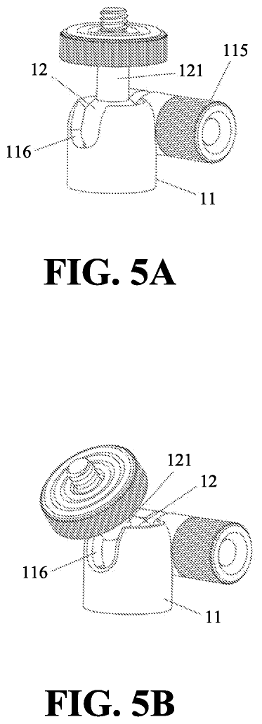

Preferably, as shown in FIG. 5A, in the first embodiment of the present invention, the main body 11 is provided with a threaded rod accommodating opening 116 opposite to the notch 14, and the threaded rod accommodating opening 116 extends from the ball body accommodating opening 113 to a proper position on the main body 11. As shown in FIG. 5B, when the fixing assembly 115 is loosened, the ball body 12 can be rotated and the threaded rod 121 can be further rotated into the threaded rod accommodating opening 116, so as to increase a swing angle of the threaded rod 121.

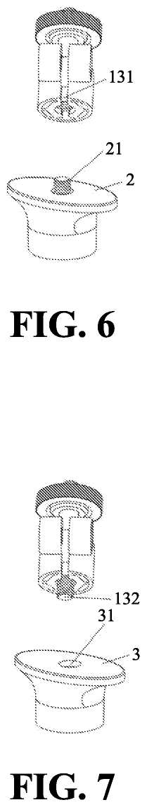

Preferably, as shown in FIG. 6, in the first embodiment of the present invention, the fastener 13 is a nut 131 and is coupled with a first object 2 through the fastener accommodating opening 114, while the first object 2 has a docking screw 21 penetrating the fastener accommodating opening 114 to be coupled with the nut 131.

Preferably, as shown in FIG. 7, in a second embodiment of the present invention, the fastener 13 is a screw 132 and is coupled with a second object 3 through the fastener accommodating opening 114, while the second object 3 has a docking nut 31, and the screw 132 penetrates the fastener accommodating opening 114 to be coupled with the docking nut 31.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A ball head, comprising:
a main body, made of an elastic material and integrally formed by a molding manner to be a single piece, wherein the main body has a ball body accommodating portion and a fastener accommodating portion, which are adjacent to each other in an up-and-down direction; the ball body accommodating portion is formed with a ball body accommodating opening extending upward to an external space, and the ball body accommodating opening has a diameter smaller than that of the ball body accommodating portion; the fastener accommodating portion is formed with a fastener accommodating opening extending downward to the external space, and the fastener accommodating opening has a diameter smaller than that of the fastener accommodating portion; the main body is provided with a notch at a side surface thereof extending from the ball body accommodating opening to the fastener accommodating opening; the ball body accommodating portion and the fastener accommodating portion are communicated with the external space through the notch; and a fixing assembly is disposed at both sides of the notch at a position close to the ball body accommodating opening;
a ball body, wherein the ball body is provided with a threaded rod extending outward therefrom; a platform is disposed on the threaded rod and provided with a platform nut at a center of the platform; and the threaded rod and the platform nut are coupled with each other and rotatable with respect to each other, so as to adjust a position of the platform relative to the threaded rod; and
a fastener, wherein in assembling, the notch of the main body is expanded to a predetermined angle, so that the fastener is placed into the fastener accommodating portion from top to bottom, the ball body is placed into the ball body accommodating portion from top to bottom from the ball body accommodating opening, and the threaded rod penetrates outward through the ball body accommodating opening, and then due to the elasticity of the main body, after the ball body is placed into the ball body accommodating portion, the both sides of the notch of the main body are forced to be close to each other; and wherein the notch is capable of being further contracted by locking the fixing assembly tight, such that the ball body accommodating portion clamps the ball body and thus the ball body is non-rotatable; and wherein the notch is also capable of being expanded by loosening the fixing assembly, such that the ball body accommodating portion releases the ball body and thus the ball body is rotatable.

2. The ball head according to claim 1, wherein the main body is provided with a threaded rod accommodating opening opposite to the notch, and the threaded rod accommodating opening extends from the ball body accommodating opening to a position on the main body.

3. The ball head according to claim 1, wherein the fastener is a nut coupled with a first object through the fastener accommodating opening.

4. The ball head according to claim 1, wherein the fastener is a screw coupled with a second object through the fastener accommodating opening.
